(19) United States
(12) Patent Application Publication
(10) Pub. No.: US 2017/0246991 A1
(43) Pub. Date: Aug. 31, 2017

(54) MULTI-FUNCTION AUTOMOTIVE CAMERA

(71) Applicant: M.I.S. Electronics Inc., Richmond Hill (CA)

(72) Inventors: Joseph E. HARTER, Kokomo, IN (US); Adil ANSARI, Kennesaw, GA (US)

(21) Appl. No.: 15/053,574

(22) Filed: Feb. 25, 2016

(51) Int. Cl. B60R 1/00; B60Q 5/00; H04N 5/232; G06T 5/00; G06K 9/00

(52) U.S. Cl. CPC B60R 1/00; G06T 5/006; G06K 9/00805; H04N 5/23293; H04N 5/23296; B60Q 5/006; B60R 2300/306; B60R 2300/602; B60R 2300/607; B60R 2300/8093

(57) ABSTRACT

Various embodiments are described herein for a vision display system for a vehicle. The system comprises at least one camera configured to capture image data of at least one zone for the vehicle, a processing unit configured to receive the image data from the at least one camera, to correct the image data to reduce distortion, and to generate final image data from the corrected image data for viewing by an operator, a passenger or a user of the host vehicle. A display is configured to output the image data.

### FIELD

The various embodiments described herein generally relate to a visual system and method for providing visual information to a vehicle operator.

### BACKGROUND

One of the problems for a vehicle operator is checking to see if there is an object behind the vehicle or in front of the vehicle when the operator's view is obstructed or to otherwise aid the operator when performing certain maneuvers. In particular, dangerous situations may occur when the vehicle operator intends to reverse the vehicle or to move the vehicle forward and cannot see an object that may be in the vehicle's path and may therefore present a threat of an accident.

### SUMMARY OF VARIOUS EMBODIMENTS

In a first broad aspect, in at least one embodiment described herein, there is provided a vision system for a host vehicle, wherein the vision system comprises at least one camera configured to capture image data of at least one zone for the host vehicle; a processing unit configured to receive the image data from the at least one camera, to correct the image data to reduce distortion, and to generate final image data from the corrected image data for viewing by an operator of the host vehicle; and a display configured to output the final image data of the at least one zone for viewing.

In at least one embodiment, the processing unit may be configured to generate the final image data for a portion of the at least one zone.

In at least one embodiment, the at least one zone is captured by image data having at least a 180 degree field of view and the processing unit may be configured to generate the final image data to have at least a 120 degree field of view within the at least one zone.

In at least one embodiment, the at least one zone is captured by image data having at least a 180 degree field of view and the processing unit may be configured to generate the final image data to have at least 180 degree field of view within the at least one zone.

In at least one embodiment, the processing unit may be configured to determine a direction of the host vehicle from an input steering angle and a forward or reverse motion of the host vehicle.

In at least one embodiment, the processing unit may be configured to change orientation of the field of view of the final image data based on the direction of the host vehicle.

In at least one embodiment, the processing unit may be further configured to add an overlay on top of the final image data, wherein the overlay is stationary and the final image data moves based on the direction of the host vehicle.

In at least one embodiment, the processing unit may be configured to generate the final image data in order to zoom in on an area of interest in the at least one zone.

In at least one embodiment, the processing unit may be configured to generate the final image data so that the area of interest is overlaid on a portion of an image presented on the display.

In at least one embodiment, the processing unit may be further configured to analyze the corrected image data to detect at least one target in the at least one zone and to generate an indication of target detection when the at least one target is detected in the at least one zone.

In at least one embodiment, the processing unit may be further configured to determine a speed and a direction of the at least one target that is detected.

In at least one embodiment, the processing unit may be further configured to compare the speed and the direction of the at least one target that is detected with a speed and the direction of the host vehicle to determine whether there is a threat of a collision between the host vehicle and the at least one target that is detected.

In at least one embodiment, the vision system may be further configured to generate an alarm signal when the at least one target is detected or when the threat of a collision is detected.

In at least one embodiment, at least one camera may be disposed along a rear portion of the vehicle and the at least one camera is generally rearward facing.

In at least one embodiment, at least one camera may disposed along a front portion of the vehicle and the at least one camera is generally frontward facing.

In another aspect, in at least one embodiment described herein, there is provided a vision display method for a host vehicle, wherein the vision display method comprises receiving image data of at least one zone for the host vehicle from at least one camera; correcting the image data to reduce distortion; generating final image data from the corrected image data for viewing by a user of the host vehicle; and outputting the final image data of the at least one zone.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which will now be briefly described.

FIG. 1 is an illustration of a host vehicle, a rear zone of the host vehicle and another vehicle entering the rear zone.

FIG. 2 is a block diagram of an example embodiment of a vision system in accordance with the teachings herein.

FIG. 3 is a flowchart of an example embodiment of a vision display method in accordance with the teachings herein.

FIG. 4 is a flowchart of an example embodiment of another vision display method in accordance with the teachings herein.

FIG. 5 is a flowchart of an example embodiment of another vision display method in accordance with the teachings herein.

Further aspects and features of the embodiments described herein will appear from the following description taken together with the accompanying drawings.

### DETAILED DESCRIPTION OF THE EMBODIMENTS

Various processes, apparatuses, devices or systems will be described below to provide an example of an embodiment of each claimed subject matter. No embodiment described below limits any claimed subject matter and any claimed subject matter may cover processes, apparatuses, devices or systems that differ from those described below. The claimed subject matter are not limited to apparatuses, processes, devices or systems having all of the features of any one apparatus, process, device or system described below or to features common to multiple or all of the apparatuses, processes, devices or systems described below. It may be possible that an apparatus, process, device or system described below is not an embodiment of any claimed subject matter. Any subject matter disclosed in an apparatus, process, device or system described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that there may be cases where the example embodiments described herein may be practiced without these specific details. In other instances, well-known methods, procedures and components have not been described in detail so as not to obscure the example embodiments described herein. Also, the description is not to be considered as limiting the scope of the example embodiments described herein in any way, but rather as merely describing the implementation of various embodiments as described herein.

It should also be noted that the terms coupled or coupling as used herein can have several different meanings depending in the context in which these terms are used. For example, the terms coupled or coupling can have a mechanical, electrical or optical, connotation. For example, depending on the context, the terms coupled or coupling may indicate that two elements or devices can be physically, electrically or optically connected to one another or connected to one another through one or more intermediate elements or devices via a physical, electrical or optical element such as, but not limited to a wire, a fiber optic cable or a waveguide, for example.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

At least a portion of the example embodiments of the systems and methods described herein, such as the detectors for example, may generally be implemented in hardware or software, or a combination of both, where possible. In some cases, the example embodiments described herein may include one or more computer programs, executing on one or more programmable computing devices comprising at least one processing unit, a data storage system (including volatile and non-volatile memory and/or storage elements), at least one input device (e.g. an input port and the like), and at least one output device (e.g. an output port, a display screen and the like).

In some of the example embodiments described herein, at least some of the programs may be implemented in a high level procedural or object oriented programming and/or scripting language or both. Accordingly, the program code may be written in C, C++, Java, SQL or any other suitable programming language and may include modules or classes, as is known to those skilled in object oriented programming. Alternatively, or in addition thereto, some of these programs may be implemented in assembly language, machine language or firmware as needed. In either case, the language may be a compiled or an interpreted language.

At least some of these programs may be stored on a storage media (e.g. a computer readable medium such as, but not limited to, ROM, a magnetic disk, an optical disc and the like) or a device that is readable by a general or special purpose computing device. The program code, when read by the computing device, configures the computing device to operate in a new, specific and predefined manner in order to perform at least one of the methods described herein.

Furthermore, at least some of the programs associated with the systems and methods of the example embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

Various embodiments are described herein that may be used to provide more visual information to a vehicle operator. Some embodiments described herein may also be used to detect an object in the rear zone or a front zone of a vehicle hereafter referred to as a host vehicle. Such objects include, but are not limited to, other vehicles such as cars, trucks, sport-utility vehicles, buses, motorcycles and bikes, for example. Other objects that can be detected in the rear zone or the front zone of the host vehicle include, but are not limited to, people, animals, and other moving objects. If another vehicle is the object that is in the zone, then it is referred to hereafter as a target vehicle (since it is a vehicle that is to be detected).

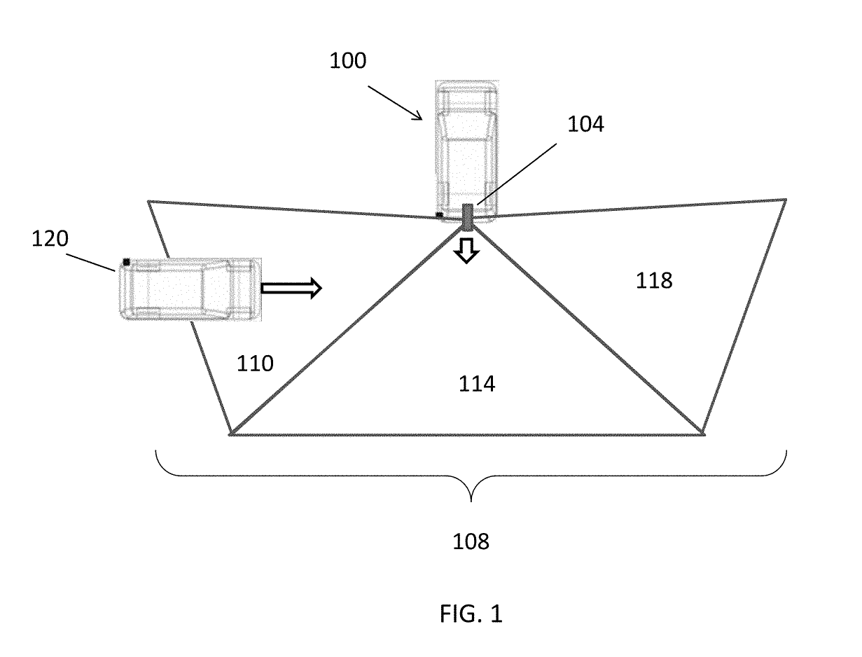

Referring now to FIG. 1, shown therein is an illustration of a host vehicle 100 and its surrounding environment. In this example embodiment, the host vehicle 100 includes a multi-function camera 104 that captures image data of at least one zone behind the vehicle. In this example, a rear zone 108 is located behind the host vehicle which may comprise a left rear zone 110, a center rear zone 114, and a right rear zone 118.

In at least one embodiment, the camera 104 is operable to obtain image data for at least a 120 degree field of view (FOV) of the rear zone 108. For example, in some cases, image data for the center zone 114 may be obtained for at least a 120 degree FOV.

In at least one embodiment, the camera 104 is operable to obtain image data for at least a 180 degree FOV of the rear zone 108. For example, in some cases, image data for the left rear zone 110, the center rear zone 114, and the right rear zone 118 may be obtained comprising at least a 180 degree FOV.

It is to be understood that the camera 104 may be implemented by any device that is operable to capture image data with a 180 degree FOV and is able to output the image data to a processing unit for further processing. For example, the camera 104 may be a video camera or a photo camera. The camera 104 is able to capture image data for consecutive images of the zones 110, 114 and 118.

In other embodiments, the host vehicle 100 may include other cameras such as at least one of a left side mirror camera and a right side mirror camera.

FIG. 1 also shows is a target vehicle 120 that is in the left rear zone 110 of the host vehicle 100. After the camera 104 has captured the image data for the left rear zone 110, the image data is processed and the processed image data is output on a display within the vehicle for viewing by the vehicle operator.

In one embodiment, the image data is not processed for automated target detection in any of the zones 110, 114 and 118 and the image data is displayed within the vehicle so that the vehicle operator or a passenger in the vehicle may visually inspect the displayed image data for any targets.

In another embodiment, the vision system can be configured to automatically detect whether there are any targets within at least one of the zones 110, 114 and 118. This may be important if the vehicle operator intends to reverse and cannot see the target. Such difficult situations are common, for example, when the vehicle operator wants to exit a parking lot or back out of a drive way and the view is obstructed by neighboring objects such as, but not limited to, parked vehicles, trees, shrubs, people and the like.

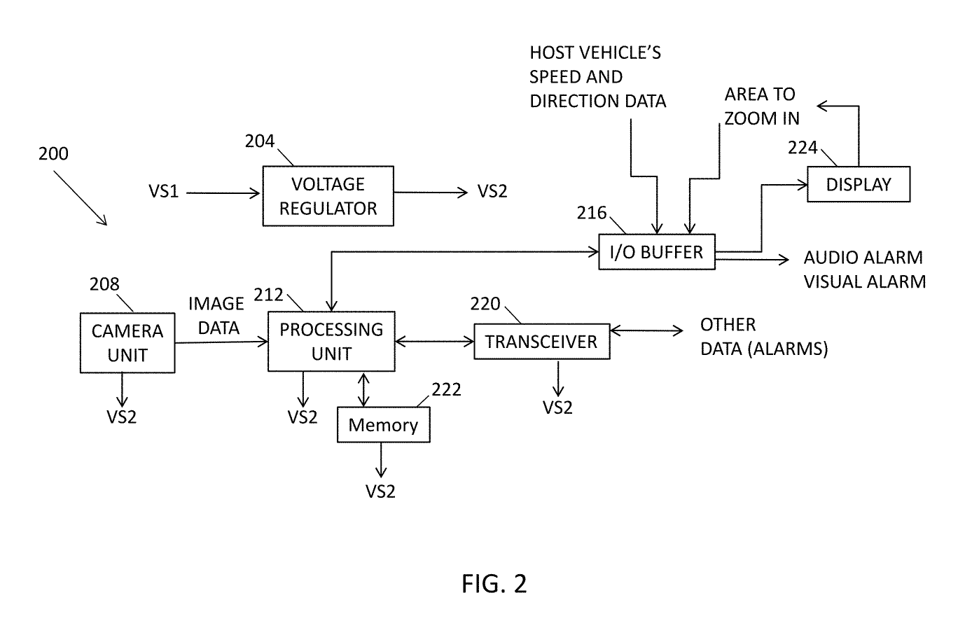

Referring now to FIG. 2, shown therein is a block diagram of an example embodiment of a vision system 200. The vision system 200 comprises a voltage regulator 204, a camera unit 208, a processing unit 212, an I/O buffer 216, a transceiver 220, memory 222 and a display 224. The camera unit 208, the I/O buffer 216 and the transceiver 220 are coupled to the processing unit 212. In alternative embodiments, other layouts and/or components may be used. For example, there can be some embodiments in which the processing unit 212 has a built-in I/O buffer.

The camera unit 208 may comprise one central camera that is mounted on a rear portion of the host vehicle 100 such that it is rearward facing.

In alternative embodiments, the camera unit 208 may include other cameras. For example, in such rearward facing embodiments, the camera unit 208 may include one or both of a left side view mirror camera and a right side view mirror camera such that these cameras face toward the rear of the host vehicle 100.

In other embodiments, the camera unit 208 has one central camera that is forward facing and the central camera unit can be mounted on a front portion of the vehicle such that it is forward facing. In alternative embodiments, the camera unit 208 may include other cameras. For example, in such rearward facing embodiments, the camera unit 208 may include one or both of a left side view mirror camera and a right side view mirror camera such that these cameras face toward the front of the host vehicle 100.

In either of the rearward or frontward facing embodiments, at least one camera of the camera unit 208 may be located such that image data is collected for a region from the corners of the bumpers to just below the bumpers.

In any of these embodiments with the different camera configurations, the cameras may provide acquired image data to the processing unit 212 via the transceiver 220. Furthermore, it is understood that analog to digital conversion occurs for analog cameras before the acquired image data is stored in memory 222 and processing by the processing unit 212.

The memory 222 can include RAM, ROM, one or more hard drives, one or more flash drives or some other suitable data storage elements. Depending on the implementation of the processing unit 212, the memory 222 may be used to store various items such as, but not limited to, an operating system and programs as is commonly known by those skilled in the art. For instance, the operating system provides various basic operational processes for the processing unit 12 when it is implemented by at least one processor. The programs may include a control program that is used to control the operation of the vision system 200 according to at least one of the image processing methods described in accordance with the teachings herein.

The I/O buffer 216 is a portion of the memory 222 that is used to temporarily store data. This storage may occur when data is transferred from one element to another such as from an input device, such as the camera unit 208, to an output device such as the transceiver or the display 224. The I/O buffer 216 may be implemented at a fixed portion of the memory 222 that is allocated for buffering or it may be implemented virtually using software that points that allocates a certain location in memory which may not be permanent.

The I/O buffer 216 is coupled to the processing unit 212 and generally receives data from the processing unit 212 as well as sends data to the processing unit 212. For example, the I/O buffer 216 is generally configured to receive the final image data generated by processing unit 212. The I/O buffer 216 may also receive an indication signal from the processing unit 212 as to whether a target is detected in one of the zones that is being monitored.

The I/O buffer 216 is also coupled to the display 224 to output the final image data to the operator and/or a passenger of the host vehicle 100. The I/O buffer 216 can also be coupled to an audio alarm or a visual alarm, or both an audio alarm and a visual alarm, to transmit the indication signal thereto in order to alert the operator of the host vehicle 100 when at least one target is detected in one of the zones being monitored. In at least some one of the embodiments, the visual alarm can be coupled to the display 224 and the audio alarm may be coupled to the sound system (not shown) of the host vehicle 100.

In at least some embodiments, the I/O buffer 216 can also be coupled to receive input data about direction of the host vehicle. For example, the direction of the host vehicle may be determined by using the input data of the steering angle.

The transceiver 220 may be used for communication purposes and can be implemented in different ways. For example, in at least one embodiment, the transceiver 220 may be a Control Area Network (CAN) transceiver that interfaces with a CAN bus to transmit and receive CAN data. This is actually a standard practice in automotive data communication. For example, the CAN data can be alarm information that is communicated via the CAN bus or the discrete I/O buffer in order to turn on an annunciator.

The voltage regulator 204 is coupled to most of the components of the system 200 to provide power to these components. The voltage regulator 204 receives a voltage V_{S1} from a power source such as, but not limited to, a battery, a fuel cell, an AC adapter, a DC adapter, a USB adapter, a battery, a solar cell or any other power source, for example, and converts the voltage V_{S1} to another voltage V_{S2} which is then used to power the components of the vision system 200. The voltage regulator 204 can be implemented in a variety of different ways depending on the voltages V_{S1} and V_{S2} and the current and power requirements of the components of the vision system 200 as is known by those skilled in the art.

The display 224 may be any suitable display that provides visual information depending on the configuration of the host vehicle 100. For instance, the display 224 may be a flat-screen monitor, an LCD-based display, a touchscreen and the like.

The processing unit 212 controls the operation of the vision system 200 and can be any suitable processor, controller or digital signal processor that can provide sufficient processing power processor depending on the configuration, purposes and requirements of the vision system 200 as is known by those skilled in the art. For example, the processing unit 212 may be a high performance general processor. In alternative embodiments, the processing unit 212 may include more than one processor with each processor being configured to perform different dedicated tasks. In alternative embodiments, specialized hardware such as, but not limited to, an Application Specific Integrated Circuit (ASIC) or a Field Programmable Gate Array (FPGA), may be used to provide some of the functions provided by the processing unit 212.

The processing unit 212 is generally configured to receive image data from the camera unit 208. The processing unit 212 can be further configured to pre-process the image data for correction or reduction of distortion to generate corrected image data. Finally, the processing unit 212 is generally configured to generate final image data from the corrected image data for viewing by the vehicle operator or a passenger of the host vehicle 100 on the display 224. The processing unit 212 may send the final image data to the I/O buffer 216 which then sends the final image data to the display 224.

The correction or reduction of distortion is important as distortion makes judgment in the region of interest difficult. Furthermore, distortion may be more pronounced when using a camera that has a wide field of view, such as about 180 degrees, for example. In these cases, the distortion correction removes the “fish bowl” effect and allows better quality images to be shown on the display 224. The better quality images allow the vehicle operator to better see any objects that may be on the periphery of the display thereby giving the vehicle operator more time to stop the vehicle or change direction to avoid a collision just as any potential targets start to be shown on the display 224.

According to the teachings herein, the image correction is achieved using, at least in part, by using image processing techniques on the image data rather than relying solely on optical techniques using additional optical elements. Distortion correction using the image processing techniques described herein is more flexible and effective compared to using additional physical optical elements.

In one embodiment, the processing unit 212 can be configured to analyze the corrected image data to detect at least one target in at least one of the zones 110, 114 and 118. The processing unit 212 may further be able to generate an indication of target detection when at least one target is detected in at least one of the zones 110, 114 and 118. This indication of target detection may be used to generate a visual or audio alarm.

In rearward vision system embodiments, the camera unit 208 is disposed along a rear portion of the host vehicle 100 and the camera 104 is generally rearward facing. If there are other cameras in the camera unit 208 then they may also be generally rearward facing.

Alternatively, in frontward vision system embodiments, the camera unit 208 is disposed along a front portion of the host vehicle 100 and the camera 104 is generally frontward facing. If there are other cameras in the camera unit 208 then they may also be generally rearward facing.

Alternatively, in bidirectional vision system embodiments, the camera unit 208 comprises cameras that are disposed along rear and front portions of the host vehicle such that some of the cameras are front facing and some of the cameras are rear facing. In such embodiments, there may be a front facing central camera and a rear facing central camera. Alternatively, in such embodiments, there may also be one or more front-side cameras and one or more rear-side cameras.

Furthermore, it should be understood that the detection techniques used for the rear left zone 110, rear center zone 114 and the rear right zone 118 may be adapted for use with other zones of the host vehicle 100, such as, for example, those that may be at the front left, front center and front right of the host vehicle 100.

Alternatively, cameras may be installed on either side of the vehicle or on all sides of the vehicle. Such cameras can provide image data to the processing unit 212 for processing for display and/or target detection. If targets are detected then the processing unit 212 can generate an alarm output to alert the host vehicle operator of any dangerous situation or a threat of a collision.

In at least some embodiments, the vision system 200 includes a first display feature in which the processing unit 212 may be configured to generate the output image data for a portion of the zone 108. For example, the processing unit 212 may generate output image data for displaying the left rear zone 110, the center rear zone 114 or the right rear zone 118. Alternatively, the processing unit 212 may be configured to generate the output image data for a portion of one of the zones 110, 114 or 118.

Alternatively, portion of the zone that is shown on the display 224, which may also be referred to as the region of interest, depends on the mode of operation. The mode of operation may include, but is not limited to, steering, reversing, and blind zone monitoring. If there is a threat condition in the region of interest, displaying that area of interest may become a higher priority if not the highest priority. The threat condition is determined based on inputs from the camera and other sensors such as, but not limited to, infrared or ultrasound sensors, for example.

In at least some embodiments, the vision system 200 includes a second display feature in which the processing unit 212 may be configured to generate a final panoramic image that results from the combination of a number of captured images. For example, when the camera unit 208 comprises at least two cameras then image data taken from both of those cameras at the same time may be combined to form a panoramic image. For a rearward facing vision system, the cameras may be the left side view camera (not shown) and the center rear camera 104, or the center rear camera 104 and the right side view camera (not shown) or all three of these cameras.

In at least some embodiments, the vision system 200 includes a third display feature in which the processing unit 212 may be configured to generate the final image data so that an area of interest is overlaid on a physical portion of the images that are output on the display 224. This may be implemented by using an overlay blending technique, for example.

In at least some embodiments, the vision system 200 includes a fourth display feature in which the processing unit 212 may be configured to generate the final image data to have a 120 degree FOV within the zone 108. This may be implemented by calculating the display area in memory 222 representing 120 degrees worth of image data and displaying it on the display 224 while masking the rest of the image data.

In at least some embodiments, the vision system 200 includes a fifth display feature in which the processing unit 212 may be configured to change the orientation of the FOV of the final image data outputted on the display 224. For example, the FOV can be changed based of the direction of the host vehicle 100. In this case, the steering angle may be used to display the desired portion of the image data in the FOV.

In at least some embodiments, the vision system 200 includes a six display feature in which the processing unit 212 may be configured to determine a speed and a direction of at least one target that is detected in one of the zones being monitored. The processing unit 212 can further analyze whether the speed of a given detected target is larger than a speed threshold. For example, the processing unit may calculate the rate at which features of the target pass through different pixels of the image data to determine the speed of the object. The processing unit 212 may further be configured to generate an alarm signal that is used to generate an audio alarm or a visual alarm.

In some of these embodiments, the speed of a given detected target, for example the speed of the target vehicle 120 in FIG. 1, may be compared to the speed and direction of the host vehicle 100. The processing unit 212 may use this speed difference information to determine a chance of cross path condition in which the host vehicle 100 and the target vehicle 120 cross paths and collide with one another. If the processing unit 212 determines that there is a threat of a crash between the host vehicle 100 and the target vehicle 120, then it may generate an alarm signal.

In at least some embodiments, the vision system 200 includes a seventh display feature in which the processing unit 212 may be configured to zoom into a particular portion of the final image data that is to be displayed on the display 224. For example, the operator or a passenger of the host vehicle 100 may choose to zoom into an area of interest in at least one of the zones being monitored. For example, the zoom in function can be used to assist the operator in connecting to a hitch for towing.

In some cases, the I/O buffer 216 may receive zoom control data regarding the area of the final image data to zoom into. The zoom control data may be sent by a user by interacting with one or more push buttons or by using their fingers if the display 224 is a touchscreen. Other input devices may also be used so that the operator or passenger of the host vehicle 100 can provide the zoom control data.

It should be noted that there may be embodiments of the vision system that include various combinations of the seven features that have been described. For example, some embodiments may contain two of the seven features, three of the seven features and so on and so forth up to some embodiments that contain all seven features.

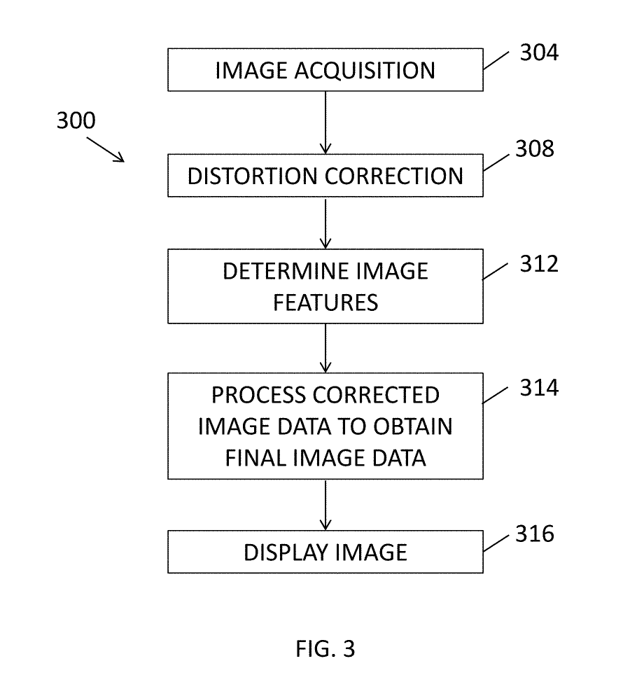

Referring now to FIG. 3, shown therein is a flowchart of an example embodiment of a vision display method 300. At 304, image data of at least a portion of the zone 108 for the host vehicle 100 is captured by the camera unit 208. In at least some embodiments, the image data is captured consecutively for the left zone 110, the center zone 114 and the right zone 118 by pivoting one rear center camera of the camera unit 208. For example, the rear center camera may scan at least a 180 degree FOV from left to right or from right to left. In another embodiment, the camera unit 208 may have a rear center camera that has a large enough field of view to capture at least a 180 degree FOV.

At 308, distortion correction is applied to the captured image data to generate corrected image data. For example, the distortion correction of the image data may be implemented to reduce the appearance of the distortion referred to as “fish-eye”. The distortion correction considerably improves the quality of the image data making it easier for the vehicle operator to determine certain things from the displayed image. For example, it is easier for the operator of the host vehicle to judge the distance between the host vehicle and a target by looking at the corrected image on the display 224. The distortion correction may include applying inverse image warping and radial distortion.

At 312, the image features are determined from the corrected image data. For example, the corrected image data may be analyzed to obtain values for various features that may be used discriminate between humans, vehicles, bicycles, motorcycles, trees, bushes, shadows and the like. Once the features are determined, then feature matching may be used to detect a target object.

At 314, the corrected image data is processed to generate final image data. The final image data may be generate to show all of the zone 108 or one of the zones 110, 114 or 118, or a portion of one of the zones 110, 114 or 118 or some combination of the zones 110, 114 or 118. Alternatively, or in addition thereto, the final image data may be generated to zoom into an area of zone 108 which may be a portion of one of or a combination of the zones 110, 114 and 118. Alternatively, or in addition thereto, the final image data may be generated such that an overlay is added to the image data. The overlay may be of dotted parallel lines that project the path of the host vehicle 100 should the vehicle operator maintain the current direction. The overlay may change colors if the vision system 100 detects a possibility of a collision. The overlay may be generated to be relatively stable while the image data changes based on the direction of the host vehicle 100 which avoids providing restricted images to the vehicle operator. This is in contrast to conventional systems in which the overlay moves but the underlying image data is the same which may result in restricted images that are provided to the vehicle operator. Other data may also be part of the overlay such as speed of the vehicle or in embodiments where a GPS unit provides data to the vision system 200, then indicators for exit numbers when travelling on freeways or nearby gas stations may be part of the overlay.

At 316, the final image data is presented on the display 224. For example, image data for the left zone 110, the center zone 114 and the right zone 118 may be shown combined in one image with at least a 180 degree FOV. As another example, the image data of only the center zone 114 with at least a 120 degree FOV may be displayed on the display 224. As another example, the image data of only the center zone 114 with at least a 140 degree FOV may be displayed on the display 224.

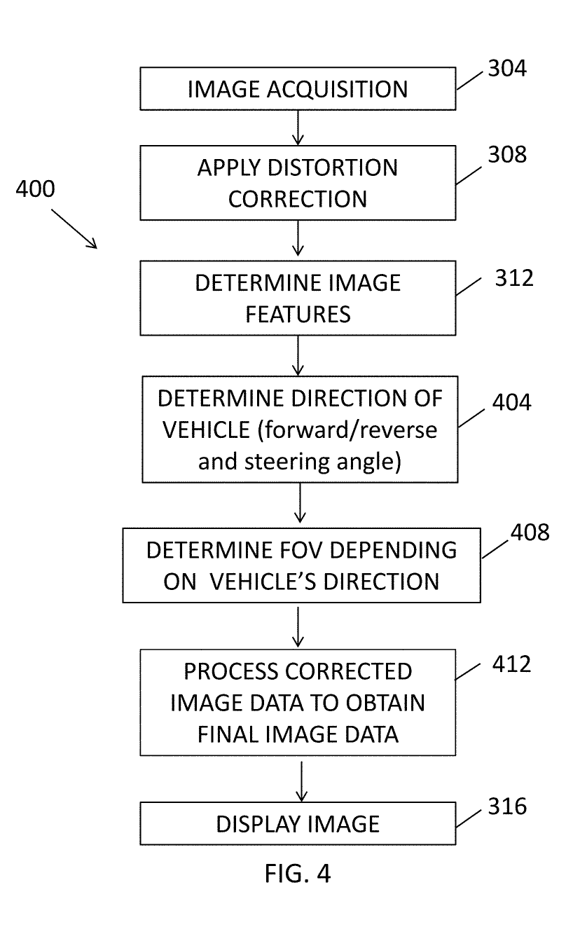

Referring now to FIG. 4, shown therein is a flowchart of another example embodiment of a vision display method 400. Acts 304, 308 and 312 have been previously described. At 404, the direction of the host vehicle 100 is determined. For example, the direction of the host vehicle 100 can be provided in the input data to the processing unit 212 based on the steering angle of the steering wheel. The reverse or forward direction of the host vehicle 100 can also be part of the input data that is provided to the host vehicle 100 by determining whether the transmission is in a forward gear or a reverse gear.

At 418, the orientation of the FOV of the image data to be presented on the display 222 is changed based on the direction of the host vehicle 100. At 314, the corrected image data is processed to generate the final image data based on the orientation of the FOV of the image data. Therefore, as the FOV of the final image data changes, based on the steering angle and direction of the host vehicle 100, the actual final image data changes. In this case, if there are any overlaid images, the orientation of the overlaid images does not change. At 316, the final image data is shown on the display 224.

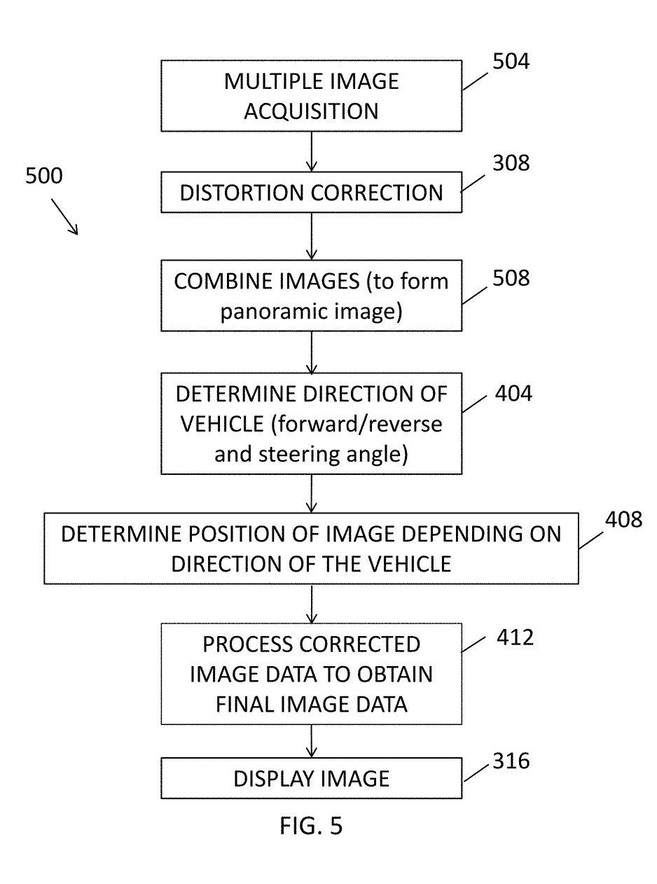

Referring now to FIG. 5, shown therein is a flowchart of another example embodiment of a vision display method 500, where image data for several images are acquired at 504. In some embodiments, the image data may be acquired by a plurality of cameras, installed along the rear of the host vehicle 100 or along the front of the host vehicle 100. In some embodiments, the image data may be obtained by a single rotating camera or a single camera as the vehicle is turning.

At 308, distortion correction is applied to the acquired image data as previously described to generate sets of corrected image data where each image data in the set is acquired at roughly the same time by different cameras. There may be sequences of sets of corrected image data where the image data from each set is acquired at a different point in time.

At 508, the sets of corrected image data are combined to form a panoramic image. For example, a transformation such as the Ransac transformation may be used to fit pixel data between two corrected image data sets of adjacent or overlapping areas so as to blend the two corrected image data sets to generate transformed image data that provides one image. Image blending and drift correction may then be applied to the transformed image data to generate panoramic image data.

At 404, the direction of the host vehicle 100 is determined as described previously. At 412, the final image data is generated from the panoramic image data such that the orientation of the FOV is changed based on the steering angle and forward or reverse direction of the host vehicle 100 as described previously. At 316, the final image data is presented on the display 224.

It should be noted that in some embodiments, a combination of panoramic and non-panoramic images may be used. For example, when the host vehicle 100 is not turning then non-panoramic images may be generated. However, when the host vehicle is turning then panoramic images may be generated.

In at least one example embodiment of a vision display method in accordance with the teachings herein, the method may be modified to perform target detection based on image features that are obtained from the corrected image data. If a target is detected in the zone 108, then an audio or visual alarm signal may generated and presented to the operator of the host vehicle 100.

In at least one example embodiment of a vision display method in accordance with the teachings herein, the final image data may be generated such that it shows a zoomed view of an area of interest in at least one of the zones 110, 114 and 118. The zoom-in area may be selected by the vehicle operator. In a further alternative, the zoom-in area may be combined with non-zoomed image data so that the zoom-in image data overlays a portion of the non-zoomed image data and this combination of zoomed and non-zoomed image data may be displayed on the display 224. This zoomed image data may assist the user of the host vehicle 100 when maneuvering in certain situations. For example, the user may zoom into an area of interest that is at an edge of one of the zones 110, 114 or 118 or when connecting to a hitch for towing or when parallel parking.

In at least one example embodiment of a vision display method in accordance with the teachings herein, the image data may be analyzed by to detect at least one target present in any part of the zone 108. If a target is detected in any part of the zone 108, then an indication may be generated and provided to the vehicle operator.

In at least one example embodiment of a vision display method in accordance with the teachings herein, the final image data is generated to comprise only a portion of a zone and is then presented on the display 224. For example, the center zone 114 may be presented on the display 224, whereas the image data for the whole zone 108 may be processed and/or analyzed for target detection.

In another example embodiment of a vision display method in accordance with the teachings herein, the speed and the direction of a detected target vehicle may be determined by analyzing the corrected image data. When the speed of the detected target vehicle is larger than a speed threshold, the vehicle operator may be alerted.

In another example embodiment of a vision display method in accordance with the teachings herein, the image data may be analyzed to determine a chance of cross path of the host vehicle 100 and the target vehicle 120 and a chance of a collision between the host vehicle 100 and the target vehicle 120. In this case, the speed and direction of the host vehicle 100 may be determined from appropriate sensors of the host vehicle 100 and the speed and the direction of the target vehicle 120 may be determined by analyzing the corrected image data. The speed and the direction of the host vehicle 100 may then be compared with the speed and the direction of the target vehicle 120 to determine if their paths will intersect. If so, then an alarm may be generated for presentation to the vehicle operator. The alarm may be an audio tone, a warning light or a highlight of the target vehicle on the display 224.

The “cross path” processing may also be used in vision systems having frontward facing cameras as this processing is useful for vehicle operators that are moving forward in an area where there may be obstructed vision, such as an alley, or between two parked cars, for example.

In at least one embodiment, the vision system 200 and the various methods described herein may become operational when the vehicle operator intends to reverse or turn the host vehicle 100. This may be determined by one or more sensors that indicate a speed of the host vehicle 100, an angle of the steering wheel of the host vehicle 100 and a turn signal indicator of the host vehicle 100. In other embodiments, image capture by the camera unit 208 can be activated when the vehicle operator intends to reverse or turn the host vehicle 100. Alternatively, the image capturing can be activated when the vehicle operator starts the engine of the host vehicle 100 or intends to move the host vehicle 100 after it has been parked.

It is to be understood that the vision display methods described herein can be used modified to implement various combinations of the vision display features described herein.

It should be known that the processing in the various display methods described herein may be carried out by a processing unit 212, such as the processing unit 212 (in combination with the other elements of vision system 200).

It should be noted that the final image data may be displayed to a user of the vehicle that is remote from the host vehicle. For example, there may be situations in which the host vehicle is remote controlled because it may be driven in a dangerous manner (such as in stunt driving), or it may be driven in a dangerous environment (such as in a war zone) in which case the final image data is displayed on a display that is local to the vehicle operator but remote from the vehicle.

Furthermore, it should be noted that in the various embodiments described herein, the operation of vision system will not change if the camera unit 208 is positioned on a rearward facing direction or a frontward facing direction for the host vehicle 100. However, some of the parameters of the various detection methods may be altered in value depending on the location of the camera(s) of the camera unit 208.

The various embodiments of the vision systems and vision display methods described herein incorporate distortion correction such that the image displayed on the display 224 is of higher quality and is more realistic in that it is a better representation of the surrounding environment of the host vehicle 100.

The various embodiments of the vision systems and vision display methods described herein typically provide a wider FOV, which allows a vehicle operator to view more of the surroundings of the host vehicle 100.

The distortion correction and increased FOV in the image data that is provided by the various embodiments of the vision systems and vision display methods described herein generally make it easier for the vehicle operator to judge the distance from the host vehicle 100 to nearby objects that are captured in the image data acquired by the camera unit 208.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims. The appended claims should be given the broadest interpretation consistent with the description as a whole.

1. A vision system for a host vehicle, wherein the vision system comprises:
at least one camera configured to capture image data of at least one zone for the host vehicle;
a processing unit configured to receive the image data from the at least one camera, to correct the image data to reduce distortion, and to generate final image data from the corrected image data for viewing by an operator of the host vehicle; and
a display configured to output the final image data of the at least one zone for viewing.

2. The vision system of claim 1, wherein the processing unit is configured to generate the final image data for a portion of the at least one zone.

3. The vision system of claim 2, wherein the at least one zone is captured by image data having at least a 180 degree field of view and the processing unit is configured to generate the final image data to have at least a 120 degree field of view within the at least one zone.

4. The vision system of claim 2, wherein the at least one zone is captured by image data having at least a 180 degree field of view and the processing unit is configured to generate the final image data to have at least 180 degree field of view within the at least one zone.

5. The vision system of claim 1, wherein the processing unit is configured to determine a direction of the host vehicle from an input steering angle and a forward or reverse motion of the host vehicle.

6. The vision system of claim 1, wherein the processing unit is configured to change orientation of the field of view of the final image data based on the direction of the host vehicle.

7. The vision system of claim 6, wherein the processing unit is further configured to add an overlay on top of the final image data, wherein the overlay is stationary and the final image data moves based on the direction of the host vehicle.

8. The vision system of claim 1, wherein the processing unit is configured to generate the final image data in order to zoom in on an area of interest in the at least one zone.

9. The vision system of claim 8, wherein the processing unit is configured to generate the final image data so that the area of interest is overlaid on a portion of an image presented on the display.

10. The vision system of claim 1, wherein the processing unit is further configured to analyze the corrected image data to detect at least one target in the at least one zone and to generate an indication of target detection when the at least one target is detected in the at least one zone.

11. The vision system of claim 10, wherein the processing unit is further configured to determine a speed and a direction of the at least one target that is detected.

12. The vision system of claim 11, wherein the processing unit is further configured to compare the speed and the direction of the at least one target that is detected with a speed and the direction of the host vehicle to determine whether there is a threat of a collision between the host vehicle and the at least one target that is detected.

13. The vision system of claim 12, wherein the vision system is further configured to generate an alarm signal when the at least one target is detected or when the threat of a collision is detected.

14. The vision system of claim 1, wherein the at least one camera is disposed along a rear portion of the vehicle and the at least one camera is generally rearward facing.

15. The vision system of claim 1, wherein the at least one camera is disposed along a front portion of the vehicle and the at least one camera is generally frontward facing.

16. A vision display method for a host vehicle, wherein the vision display method comprises:
receiving image data of at least one zone for the host vehicle from at least one camera;
correcting the image data to reduce distortion;
generating final image data from the corrected image data for viewing by a user of the host vehicle; and
outputting the final image data of the at least one zone.

17. The method of claim 16, wherein the method further comprises generating the final image data for a portion of the at least one zone.

18. The method of claim 17, wherein the method further comprises capturing the image data to have a 180 degree field of view and generating the final image data to have at least a 180 degree field of view.

19. The method of claim 17, wherein the method further comprises capturing the image data to have a 180 degree field of view and generating the final image data to have at least a 120 degree field of view within the at least one zone.

20. The method of claim 16, wherein the method further comprises determining a direction of the host vehicle from an input steering angle and a forward or reverse motion of the host vehicle.

21. The method of claim 16, wherein the method further comprises changing orientation of the field of view of the final image data based on the direction of the host vehicle.

22. The method of claim 21, wherein the method further comprises adding an overlay on top of the final image data, wherein the overlay is stationary and the final image data moves based on the direction of the host vehicle.

23. The method of claim 16, wherein the method further comprises generating the final image data in order to zoom in on an area of interest in the at least one zone.

24. The method of claim 23, wherein the method further comprises generating the final image data so that the area of interest is overlaid on a portion of the final image data.

25. The method of claim 16, wherein the method further comprises detecting at least one target in the at least one zone and generating an indication of target detection when the at least one target is detected in the at least one zone.

26. The method of claim 25, wherein the method further comprises generating an alarm signal when the at least one target is detected.

27. The method of claim 25, wherein the method further comprises determining a speed and a direction of the at least one target that is detected.

28. The method of claim 27, wherein the method further comprises determining whether there is a threat of a crash between the host vehicle and the at least one target that is detected.

29. The method of claim 27, wherein the method further comprises comparing the speed and direction of the at least one target that is detected with the speed and direction of the host vehicle and determining whether there is a threat of a crash between the host vehicle and the at least one target that is detected.

30. The method of claim 29, wherein the method further comprises generating an alarm signal when a threat of a crash is determined between the host vehicle and the at least one target that is detected.
